(19) United States
(12) Patent Application Publication
(10) Pub. No.: US 2018/0060942 A1
(43) Pub. Date: Mar. 1, 2018

(54) CHARITABLE AND NON-PROFIT MOBILE APPLICATIONS

(71) Applicant: EDUVIJES VICKI CRUZ, HOUSTON, TX (US)

(72) Inventor: EDUVIJES VICKI CRUZ, HOUSTON, TX (US)

(21) Appl. No.: 15/250,829

(22) Filed: Aug. 29, 2016

(51) Int. Cl. G06Q 30/06

(52) U.S. Cl. CPC G06Q 30/0639

(57) ABSTRACT

A system for locating events of charitable and non-profit organizations via a mobile application, and more particularly to a charitable and non-profit mobile application as used to improve the ability of a user to search, locate and interact with multiple non-profit and mobile applications. The charitable and non-profit mobile application may include a log-in-module, a search-module, an event-manager-module, an organization-module, and a map-module.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of mobile applications and more specifically relates to a system for locating events using a mobile application.

### 2. Description of Related Art

A charitable organization is a type of non-profit organization which differs from other types of non-profit organizations in that a charitable organization works towards philanthropic goals, as well as social well-being. Such goals may include charitable, educational, religious, or other activities serving the public interest or common good.

Financial figures can be important factors to assess the financial longevity of a charity, especially to charity evaluators. This information may impact a charity's reputation with donors and the general public, and may highly impact the charity's financial income.

Charitable organizations most heavily depend partly on donations from for-profit-organizations. In some instances, donors may seek out a charitable organization based upon the organization's goals, geographic influence, and status. One limitation with charitable organizations is that, often times, the charitable organization does not have the funding to provide marketing campaigns for the organization. Additionally, it may be difficult for a potential donor to locate a charitable organization or evaluate multiple organizations easily. Therefore a suitable solution is desired.

Several attempts have been made to solve the above-mentioned problems such as those found in U.S. Publication numbers: 2014/0164275 to Lee; 2013/0159117 to Sanginiti et al.; 2014/0164160 to Forman; 2014/0222701 to Loh et al.; 2014/0214707 to Magedman et al.; and 2013/0204779 to Marinakis et al. This art is representative of mobile applications. However, none of the above references, taken either singly or in combination, is seen to describe the invention as claimed.

### BRIEF SUMMARY OF THE INVENTION

In view of the foregoing disadvantages inherent in the known mobile application art, the present disclosure provides a novel charitable and non-profit mobile application. The general purpose of the present disclosure, which will be described subsequently in greater detail, is to provide a program to provide a user with the ability to search, manage, and organize a wide variety of charitable organizations in a single computer operable program.

A charitable and non-profit mobile application is disclosed in a preferred embodiment comprising a log-in-module, a search-module, an event-manager-module, an organization-module, and a map-module.

The log-in-module provides a user-interface, such that only an authorized-user may access said charitable and non-profit mobile application, and the search-module allows the authorized-user with an ability to enter keywords to find a specific charitable-organization. The event-manager-module allows the authorized-user to maintain, store and organize information related to events for charitable-organizations, and the organization-module maintains, stores, and organizes information related to those charitable-organizations.

The map-module provides the authorized-user with a visual-indication of locations of charitable-organizations on a searchable map-display. Also included in the preferred embodiment of the charitable and non-profit mobile application, is a shopping-module, with the shopping-modules providing the user with the ability to purchase goods (e.g., clothing, stationary, calendars, etc.) via the charitable and non-profit mobile application. The shopping-module preferably includes both a “pay-now” and a “bill-me” option, such that the user may select the time of payment for his or her purchase via the shopping-module.

The charitable and non-profit mobile application comprises, at least, the log-in-module, the search-module, the event-manager-module, the organization-module, and the map-module, all in functional combination, are configured to provide the authorized-user with a computer-executable-program useful for finding charitable-organizations as a tangible output.

The organization-module of the charitable and non-profit mobile application preferably includes an organization-icon, an organization-location, an organization-name, an organization-type, an organization-status, and organization-details, all in a display viewable via the computer-executable-program.

Preferably, the log-in-module includes an email-query, a password-query and a register-option, all in a single display. Also, the search-module preferably includes a location-query, a search-term-query, and a distance-query, all in a single display. Similarly, the event-manager-module preferably includes a promotion-option, a date-query, a time-query, and a location-entry. Likewise, the map-module includes a zip-code-query, a distance-radius-query, and an organizational-type-query.

In the preferred embodiment, charitable-organizations included in the charitable and non-profit mobile application include (but are not limited to) religious organizations, health-and-wellness organizations, elderly-care organizations, medical organizations, and educational organizations.

Preferably, the charitable and non-profit mobile application is operable upon a wide variety of computer-like devices, where the computer-executable-program is operable upon devices including (but not limited to) a smart-phone, a smart-watch, a tablet-computer, a laptop-computer, and/or a desktop-computer.

The present disclosure holds significant improvements and serves as a charitable and non-profit mobile application. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein, without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present disclosure, charitable and non-profit mobile application, constructed and operative according to the teachings of the present disclosure.

FIG. 1 shows a chart illustrating the various modules of a charitable and non-profit mobile application according to one embodiment of the present disclosure.

FIG. 2 illustrates the log-in-module of the charitable and non-profit mobile application of FIG. 1, according to an embodiment of the present disclosure.

FIG. 3 illustrates the organization-module of the charitable and non-profit mobile application of FIGS. 1 and 2, according to an embodiment of the present disclosure.

FIG. 4 illustrates the map-module of the charitable and non-profit mobile application of FIGS. 1-3, according to an embodiment of the present disclosure.

FIG. 5 illustrates the event-manager-module of the charitable and non-profit mobile application of FIGS. 1-4, according to an embodiment of the present disclosure.

The various embodiments of the present disclosure will hereinafter be described in conjunction with the appended drawings, wherein like designations denote like elements.

### DETAILED DESCRIPTION

Preferably, a charitable and non-profit mobile application should provide a program operable by an electronic device to provide a user with a tool to organize, search, and interact with multiple charitable organizations, and, yet would operate reliably and be manufactured at a modest expense. Thus, a need exists for a reliable charitable and non-profit mobile application to avoid the above-mentioned problems.

As discussed above, embodiments of the present disclosure relate to a system for locating events of charitable and non-profit organizations via a mobile application, and more particularly to a charitable and non-profit mobile application as used to improve the ability of a user to search, locate and interact with multiple non-profit and mobile applications.

Generally speaking, the system for locating events of charitable and non-profit organizations and the charitable and non-profit mobile application may include a mobile device, a backend server, a log-in-module, a search-module, an event-manager-module, an organization-module, and a a map-module.

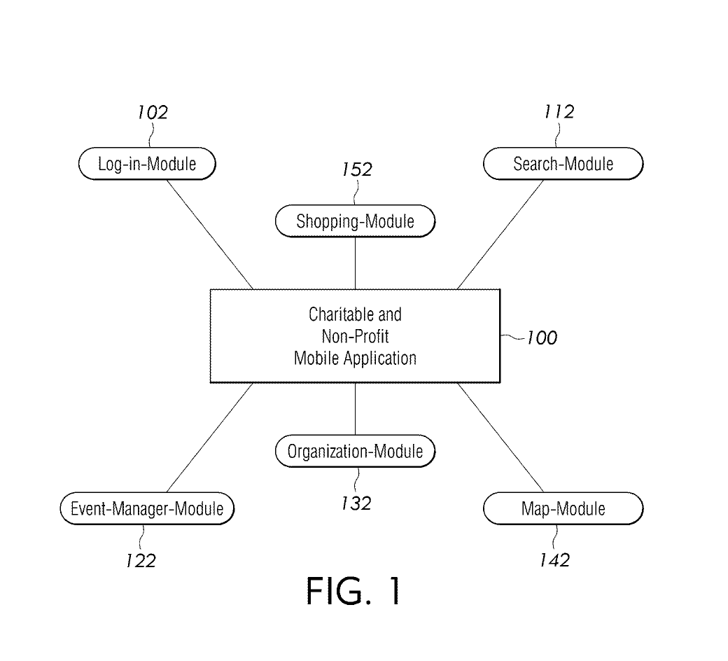

Referring to the drawings by numerals of reference, there is shown in FIGS. 1-5, the system for locating events of charitable and non-profit organizations via charitable and non-profit mobile application 100, according to an embodiment of the present disclosure. The system or charitable and non-profit mobile application 100 may comprise a mobile device (such as smart-phone 180) which may include a processor, a memory, a user interface, and a transceiver, the transceiver being configured to communicate over a communication link, and further comprise a backend server being configured to communicate with the mobile device over the communication link via the transceiver.

Charitable and non-profit mobile application 100 may further comprise log-in-module 102 communicably coupled to the user interface, search-module 112 communicably coupled to the communication link and to the user interface, event-manager-module 122 communicably coupled to at least one of the backend server and the memory, organization-module 132 communicably coupled to at least one of the backend server and the memory, map-module 142 communicably coupled to the user interface. Some embodiments of charitable and non-profit mobile application 100 may additionally include shopping-module 152, with shopping-module 152 being configured to allow authorized-users 133 to purchase goods via charitable and non-profit mobile application 100. Shopping-module 152 may include a pay-now and a bill-me option.

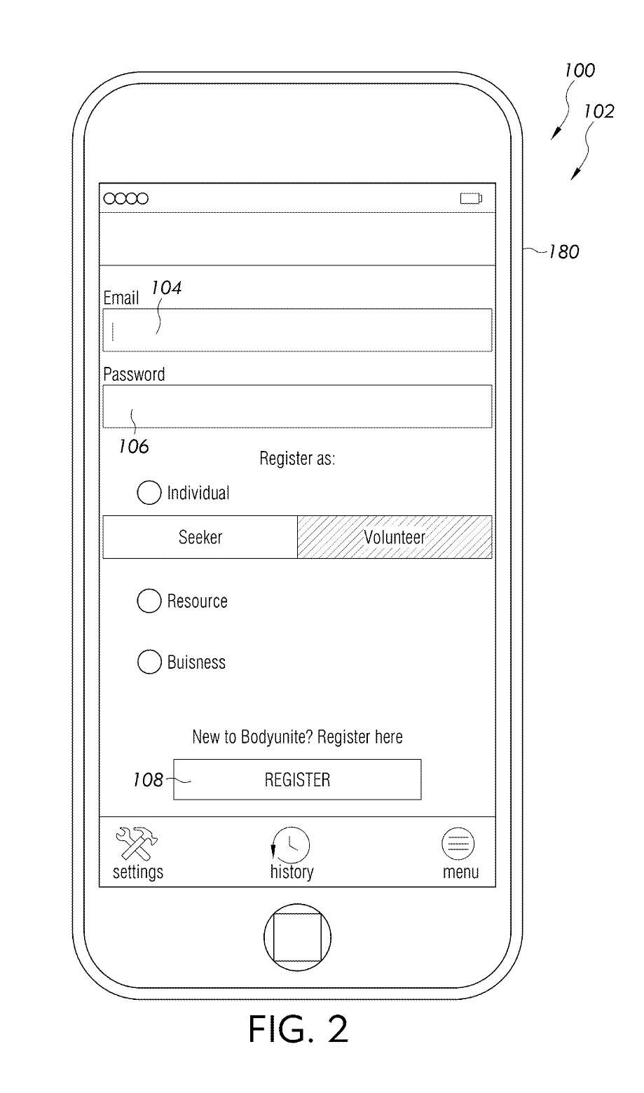

FIG. 2 illustrates the log-in-module of the charitable and non-profit mobile application according to an embodiment of the present disclosure of FIG. 1. Log-in-module 102 may be configured to receive verification-information about a user from the user interface and to determine whether the user is authorized, log-in-module 102 may further be configured to limit access to the system such that only an authorized-user may access the system and may include email-query 104, password-query 106, and register-option 108. Search-module 112 (FIG. 1) may be configured to provide authorized-users with access to enter keywords into the user interface. Search-module 112 may be further configured to send keywords over the communication link to be used to find a desired-organization, the desired organization being at least one of a charitable organization and a non-profit organization.

Search-module 112 may include location-query, search-term-query, and distance-query.

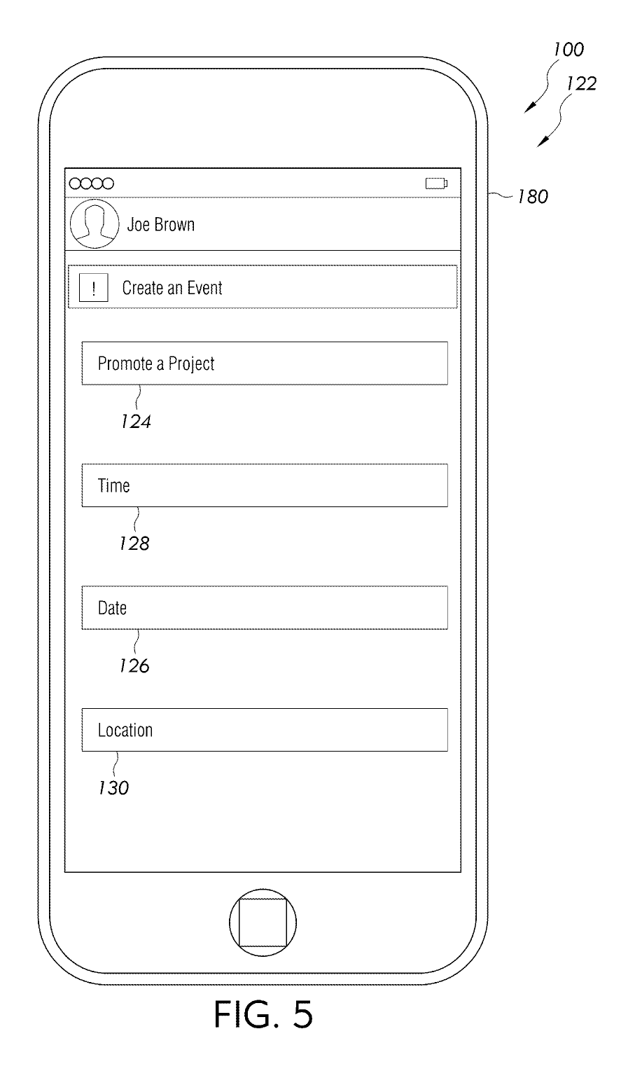

FIG. 5 illustrates the event-manager-module of the charitable and non-profit mobile application of FIGS. 1-4, according to an embodiment of the present disclosure. Event-manager-module 122 may be configured to allow authorized-users to maintain, store, and organize information related to the events of the charitable and non-profit organizations, and may include promotion-option 124, date-query 126, time-query 128, and location-entry 130 in some embodiments.

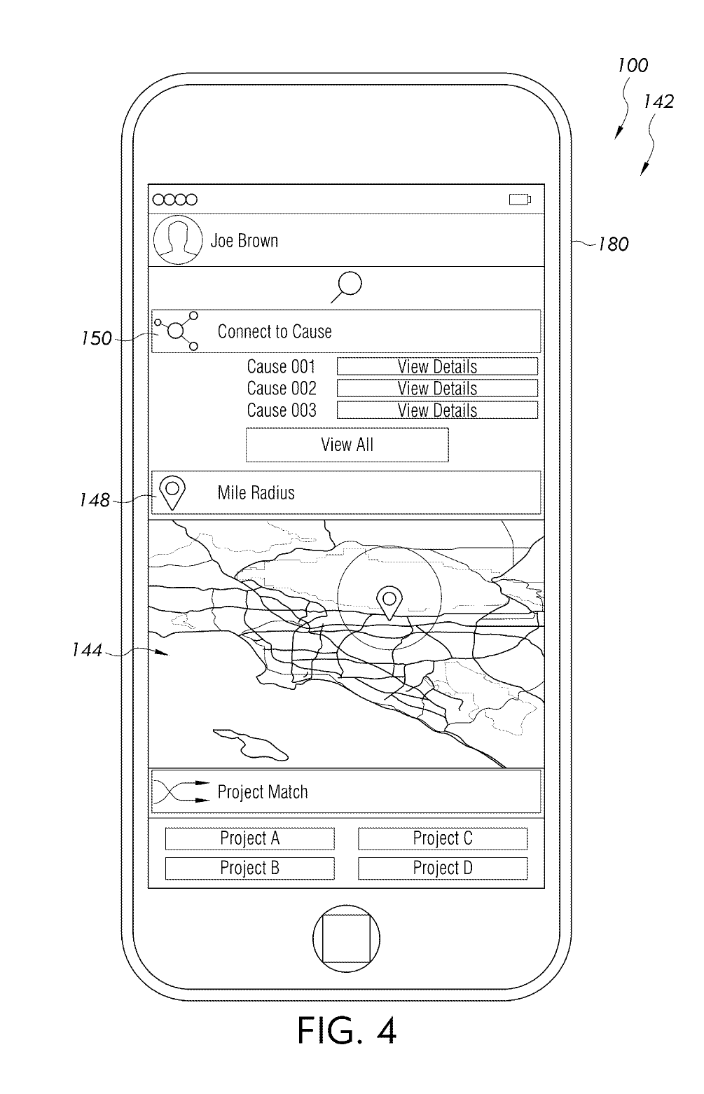

FIG. 4 illustrates the map-module of the charitable and non-profit mobile application of FIGS. 1-3, according to an embodiment of the present disclosure. Map-module 142 may be configured to provide authorized-users with a visual-indication of locations of the charitable and non-profit organizations and of the events of the charitable and non-profit organizations on a map-display 144 via the user interface, and may additionally include zip-code-query, distance-radius-query 148, and organizational-type 136 query.

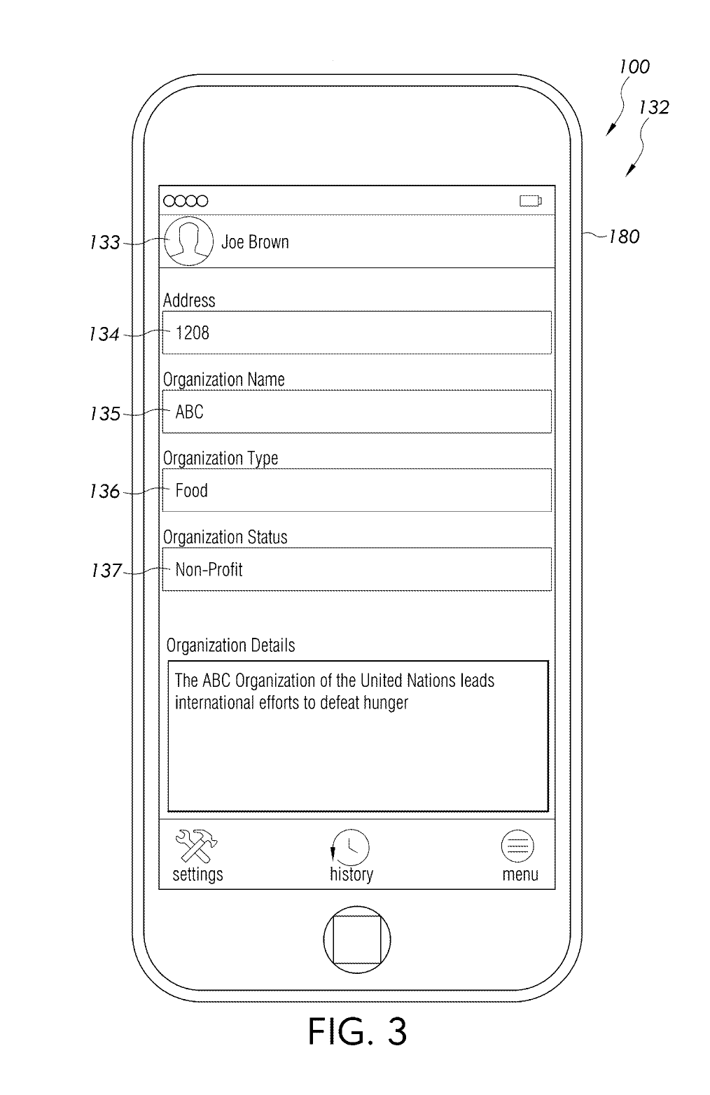

FIG. 3 illustrates the organization-module of the charitable and non-profit mobile application of FIGS. 1 and 2, according to an embodiment of the present disclosure. Organization-module 132 may be configured to maintain, store, and organize information related to the charitable and non-profit organizations and to the events of the charitable and non-profit organizations. Organization-module 132 may be further configured to provide to authorized-users 133 via the user interface organization-icon, organization-location 134, organization-name 135, organization-type 136, organization-status 137, and organization-details.

A system for locating events of charitable and non-profit organizations may be directed toward religious organizations, health-and-wellness organizations, elderly-care organizations, medical organizations, and/or educational organizations. System for locating events of charitable and non-profit organizations may be operable on a variety of mobile devices including a smart-television, smart-phone 180, smart-watch, tablet-computer, laptop-computer, and/or desktop-computer, and accessible via the charitable and non-profit mobile application 100.

It should be noted that the steps described in the method of use can be carried out in many different orders according to user preference. The use of “step of” should not be interpreted as “step for”, in the claims herein and is not intended to invoke the provisions of 35 U.S.C. § 112(f).

The embodiments of the disclosure described herein are exemplary and numerous modifications. Variations and rearrangements can be readily envisioned to achieve substantially equivalent results, all of which are intended to be embraced within the spirit and scope of the disclosure. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A system for locating events of charitable and non-profit organizations, the system comprising:
a mobile device including a processor, a memory, a user interface, and a transceiver, said transceiver configured to communicate over a communication link;
a backend server configured to communicate with the mobile device over the communication link via the transceiver;
a log-in-module communicably coupled to the user interface, said log-in-module configured to receive verification-information about a user from the user interface and to determine whether said user is authorized, said log-in-module further configured to limit access to the system such that only an authorized-user may access the system;
a search-module communicably coupled to the communication link and to the user interface, said search-module configured to provide authorized-users with access to enter keywords into the user interface, said search-module further configured send said keywords over the communication link to be used to find a desired-organization, said desired organization being at least one of an charitable organization and a non-profit organization;
an event-manager-module communicably coupled to at least one of the backend server and the memory, the event-manager-module configured to allow authorized-users to maintain, store, and organize information related to the events of the charitable and non-profit organizations;
an organization-module communicably coupled to at least one of the backend server and the memory, the organization-module configured to maintain, store, and organize information related to the charitable and non-profit organizations and to the events of the charitable and non-profit organizations; and
a map-module communicably coupled to the user interface, the map-module configured to provide authorized-users with a visual-indication of locations of the charitable and non-profit organizations and of the events of the charitable and non-profit organizations on a map-display via the user interface.

2. The system of claim 1 further comprising a mobile application, said mobile application including a shopping-module, the shopping-module configured to allow authorized-users to purchase goods via the mobile application.

3. The system of claim 2, wherein said organization-module is further configured to provide to authorized-users an organization-icon, an organization-location, an organization-name, an organization-type, an organization-status, and organization-details via the user interface.

4. The system of claim 2, wherein said log-in-module includes an email-query, a password-query, and a register-option.

5. The system of claim 2, wherein said search-module includes a location-query, a search-term-query, and a distance-query.

6. The system of claim 2, wherein said event-manager-module includes a promotion-option, a date-query, a time-query, and a location-entry.

7. The system of claim 2, wherein said map-module includes a zip-code-query, a distance-radius-query, and an organizational-type-query.

8. The system of claim 2, wherein said shopping-module includes a pay-now and a bill-me option.

9. The system of claim 2, wherein said charitable and non-profit organizations include religious organizations.

10. The system of claim 2, wherein said charitable and non-profit organizations includes health-and-wellness organizations.

11. The system of claim 2, wherein said charitable and non-profit organizations includes elderly-care organizations.

12. The system of claim 2, wherein said charitable and non-profit organizations includes medical organizations.

13. The system of claim 2, wherein said charitable and non-profit organizations includes educational organizations.

14. The system of claim 2, wherein said mobile device is operable in conjunction with a smart-television.

15. The system of claim 2, wherein said mobile device is a smart-phone.

16. The system of claim 2, wherein said mobile device is a smart-watch.

17. The system of claim 2, wherein said mobile device is a tablet-computer.

18. The system of claim 2 wherein said mobile device is a laptop-computer.

19. The system of claim 2, wherein said mobile device is operable in conjunction with a desktop-computer.

20. A charitable and non-profit mobile application comprising:
a log-in-module;
a search-module;
an event-manager-module;
an organization-module; and
a map-module;
wherein said log-in-module provides a user-interface such that only an authorized-user may access said charitable and non-profit mobile application;
wherein said search-module allows said authorized-user with an ability to enter keywords to find a specific charitable-organization;
wherein said event-manager-module allows said authorized-user to maintain, store, and organize information related to events for charitable-organizations;
wherein said organization-module maintains, stores, and organizes information related to charitable-organizations;
wherein said map-module allows said authorized-user with a visual-indication of locations of charitable-organizations on a map-display;
wherein said charitable and non-profit mobile application comprises said log-in-module, said search-module, said event-manager-module, said organization-module, and said map-module, all in functional combination to provide said authorized-user with a computer-executable-program useful for finding charitable-organizations as a tangible output;
wherein said charitable and non-profit mobile application further comprises a shopping-module to allow said user to purchase goods via said charitable and non-profit mobile application;
wherein said organization-module includes an organization-icon, an organization-location, an organization-name, an organization-type, an organization-status, and organization-details;
wherein said log-in-module includes an email-query, a password-query, and a register-option;
wherein said search-module includes a location-query, a search-term-query, and a distance-query;
wherein said event-manager-module includes a promotion-option, a date-query, a time-query, and a location-entry;
wherein said map-module includes a zip-code-query, a distance-radius-query, and an organizational-type-query;
wherein said shopping-module includes both a pay-now and a bill-me option;
wherein said charitable-organizations includes religious organizations, health-and-wellness organizations, elderly-care organizations, medical organizations, and educational organizations; and
wherein said computer-executable-program is operable upon a smart-phone, a smart-watch, a tablet-computer, a laptop-computer, and a desktop-computer.
